(19) United States
(12) Patent Application Publication
(10) Pub. No.: US 2009/0145026 A1
(43) Pub. Date: Jun. 11, 2009

(54) SYSTEM FOR GROWING PLANT MATERIAL ON A BUILDING AND METHOD OF ASSEMBLING PLANT-GROWTH SUPPORT SYSTEM ON A BUILDING

(76) Inventor: Terry D. Daglow, Bonham, TX (US)

Correspondence Address: Terry Daglow;c/o Chris Crawford, 12132 Terrazzo Lane, Frisco, TX, 75035, US

(21) Appl. No.: 12/271,845

(22) Filed: Nov. 15, 2008

Related U.S. Application Data
(60) Provisional application No. 60/988,251, filed on Nov. 15, 2007.

(51) Int. Cl. A01G 9/02

(52) U.S. Cl. 47/65.9; 47/79; 47/66.7

(57) ABSTRACT

In one embodiment, a system for supporting plant growth on a roof of a building, comprises: a water-impervious base structure; a water-permeable cover; porous material, held between the base structure and the cover, for providing a root base for the plant growth; one or more irrigation channels for permitting delivery of water through the base structure or cover to the synthetic or natural soil; the cover being further adapted to permit growth of plant material from the porous material through to an exterior of the cover.

### RELATED APPLICATION

This application claims the benefit of U.S. Provisional Patent Application Ser. No. 60/988,251, filed Nov. 15, 2007, entitled “SYSTEM FOR GROWING PLANT MATERIAL ON A BUILDING AND METHOD OF ASSEMBLING PLANT-GROWTH SUPPORT SYSTEM ON A BUILDING,” which is incorporated herein by reference.

### BACKGROUND

Global warming refers to the increase in the average near-surface air temperature and the increase in average ocean temperature of the Earth that has occurred in recent decades and the expected increase in such temperatures in the immediate future. The global average air temperature has increased approximately 0.74° C. during the previous 100 years. A number of climate models have predicted further increases of 1.1° to 6.4° C. by 2100. The cause of the increase air temperature is due to the increase in greenhouse gas concentrations within the atmosphere. Carbon dioxide is the one of the most prevalent greenhouse gases linked to global warming. Increases in carbon dioxide have primarily occurred as a result of use of fossil fuels.

Reduction in the use of fossil fuels has been proposed to mitigate global warming. For example, the Kyoto Protocol to the United Nations Framework Convention on Climate Change attempts to assign mandatory emission limitations for the reduction of greenhouse gas emissions to the signatory nations. Other regulatory schemes have attempted to regulate greenhouse gas emissions using other means. For example, carbon offset credits have been proposed to allow the emission of carbon dioxide relative to a commiserate reduction in carbon dioxide achieved by another activity.

In addition to government regulation, less formal and local activities have been proposed to reduce greenhouse gases. It has been suggested that individuals should attempt to reduce their “carbon footprint.” The use of fuel efficient vehicles, use of energy efficient appliances, reduced consumption of consumer goods have been adopted by some segments of the population. The thought behind such activities is that there is no single solution to global warming and a variety of changes in everyday life are necessary to address to the problem.

### SUMMARY

In one embodiment, a system for supporting plant growth on a roof of a building, comprises: a water-impervious base structure; a water-permeable cover; porous material, held between the base structure and the cover, for providing a root base for the plant growth; one or more irrigation channels for permitting delivery of water through the base structure or cover to the synthetic or natural soil; the cover being further adapted to permit growth of plant material from the porous material through to an exterior of the cover.

The foregoing has outlined rather broadly certain features and/or technical advantages in order that the detailed description that follows may be better understood. Additional features and/or advantages will be described hereinafter which form the subject of the claims. It should be appreciated by those skilled in the art that the conception and specific embodiment disclosed may be readily utilized as a basis for modifying or designing other structures for carrying out the same purposes. It should also be realized by those skilled in the art that such equivalent constructions do not depart from the spirit and scope of the appended claims. The novel features, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the appended claims.

### BRIEF DESCRIPTION OF THE DRAWINGS

FIGS. 1A-1D depict respective plant support structures adapted to be affixed to the roof of a dwelling according to some representative embodiments.

FIG. 2 depicts a base structure including a load strap according to one representative embodiment.

FIG. 3 depicts a base structure and cover circumscribed by an anti-expansion band according to one representative embodiment.

FIG. 4 depicts an array of support structures mechanically coupled together according to one representative embodiment.

FIG. 5 depicts a support structure comprising a soaker hose for distributing moisture to porous material within the support structure according to one representative embodiment.

FIG. 6 depicts a disassembled view of a support structure according to one representative embodiment.

### DETAILED DESCRIPTION

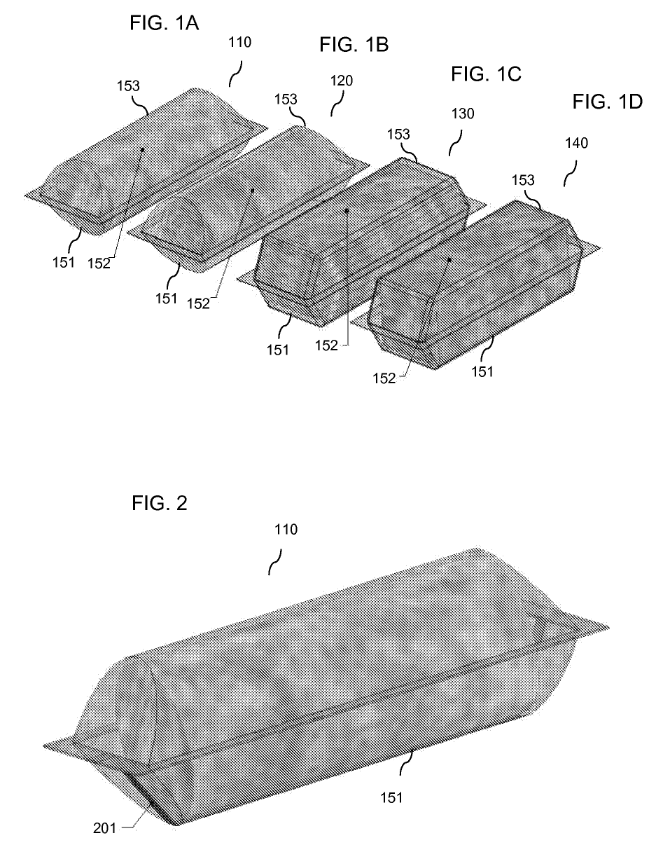

FIGS. 1A-1D depict respective plant support structures 110, 120, 130, and 140 adapted to be affixed to the roof of a dwelling according to some representative embodiments. The roof may be flat or angled. Each plant support structure 110, 120, 130, and 140 comprise a non-permeable base structure 151 for retaining soil, nano or micro structure simulating soil, fused or bonded polymer fibers, open cell foam, or any other porous material 152 that is capable of supporting plant growth. In preferred embodiments, base structure 151 is preferably fabricated using a relatively rigid and durable plastic material. Each structure 110, 120, 130, and 140 further comprises a respective permeable cover 153. Screen or shade cloth can be used for cover 153 according some embodiments.

As shown in FIGS. 1A-1D, base structure 151 and/or cover 153 may take a curved or substantially box-like shape. Base structure 151 and cover 153 need not possess the same profile. Base structure 151 could be relatively flat while cover 153 could be curved according to an alternative embodiment. The exact form of support structures 110, 120, 130, and 140 is not critical to the invention. Porous material 152 can also be provided in a number of forms. For example, a solid soil root base, a spiral soil root base, or a layered soil root base could be used according to some representative embodiments.

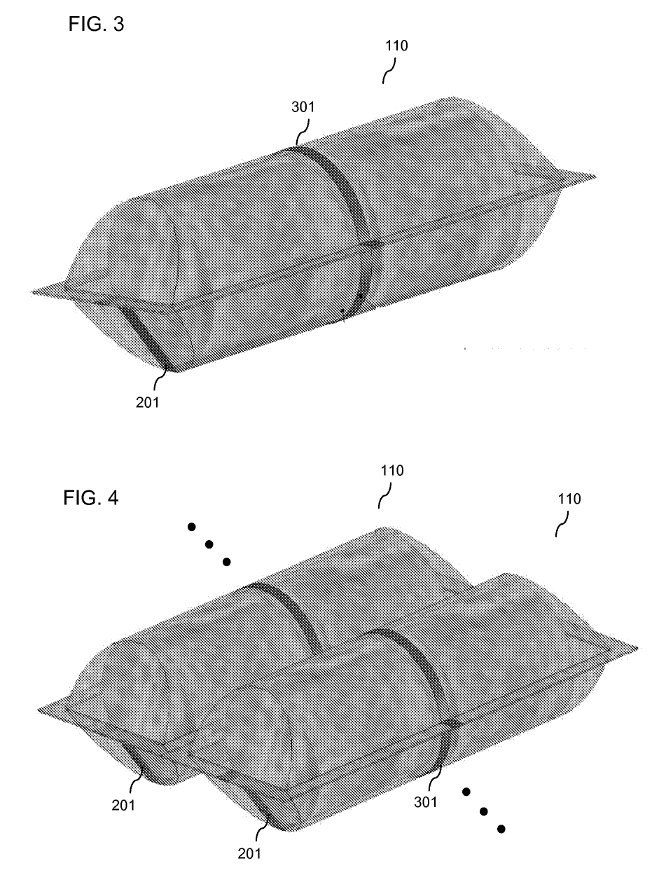

In some embodiments, load strap 201 may be applied to base structure 151 for the purpose of strengthening base structure 151 and preventing flexing of base structure 151 during installation as shown in FIG. 2. Base structure 151 may comprise a lateral slot (no shown) along its bottom surface that corresponds to the profile of strap 201. Base structure 151 and cover 153 are preferably mechanically coupled along their perimeters. If suitable thermoplastic material is employed for base structure 151 and cover 153, the mechanical coupling can be achieved by fusing structure 151 and cover 153 together along their perimeters. Alternatively, suitable epoxy adhesives could be employed to seal soil 152 within the confines defined by base structure 151 and cover 153. Sowing, stapling, clamping, riveting, or any other suitable coupling may also be employed. In another embodiment, cover 153 and base structure 151 may be held by anti-expansion band 301 as shown in FIG. 3.

In preferred embodiments, an array of support structures 110, 120, 130, or 140 are mechanically coupled (as shown in FIG. 4) together edge to edge to facilitate placement on the roof of a dwelling an efficient manner. A connected series of base structures 151 and a connected series of covers 153 may be fabricated and, then, each series can be joined together to form an array. Alternatively, a number of pairs of base structures 151 and covers 153 may be joined together and, then, pairs of the base structures 151 and covers 153 may be joined in a successive manner to form an array. In one embodiment, the plastic material between adjacent base structures 151 and covers 153 is somewhat pliable. The flexibility between adjacent base structures 151 and covers 153 enables an array to be rolled or folded into a relatively compact shape. The array in such a form can be lifted onto the roof of a dwelling in a relatively straight-forward manner and unrolled for attachment to the roof.

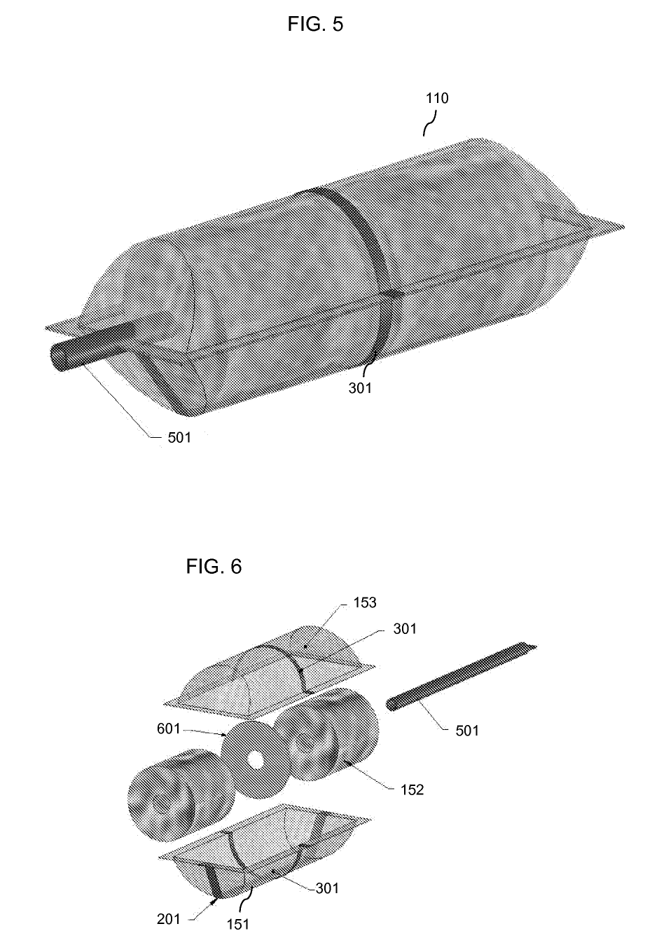

In another representative embodiment, an irrigation channel is integrated within the support structure to deliver water and nutrients to the soil or porous material 152. As shown in FIG. 5, soaker hose 501 preferably extends axially within the confines of structure 110. Preferably, soaker hose 501 comprises multiple apertures (not shown) within structure 110 for dispensing water and nutrients to soil 152. Preferably, one or both ends of soaker hose 501 protrude from structure 110. The soaker hose 501 may be threaded through multiple structures 110. Alternatively, each structure 110 may comprise its own soaker hose 152 and suitable intermediate connections could connect between each structure 110 to enable delivery of water throughout the entire array of structures 110. In some embodiments, soaker hose 501 of an array of support structures is adapted to couple a soaker hose 501 of another array of support structures in a modular manner. Installation may occur in an efficient manner due to modular connectivity of the arrays of support structures. Also, if any one array is damaged, the damaged array may be easily removed and a replacement array can be quickly provided. In one embodiment, one or more sensors (not shown) may be included within an array of support structures to measure the moisture content of soil 152. A water source may be automatically controlled in response to signals from the moisture sensor.

FIG. 6 depicts a disassembled view of structure 110 according to one representative embodiment. As shown in FIG. 6, soil segments 152 preferably comprise an aperture for receiving soaker hose 501. In the embodiment of FIG. 6, two separate soil segments 152 are employed, although any suitable number could be selected in relation to the length of structure 110. Also, in the embodiment of FIG. 6, soil barrier spacers 601 are placed between each soil segment 152. Each soil segment 152 need not be made of the same material and need not be of the same length, size, or cross-sectional shape. In alternative embodiments, resistive heating structures (not shown) could be integrated with or disposed below base structure 151 for use in less temperate climates.

Plant material may be provided within structures 110, 120, 130, and 140 upon fabrication, upon or shortly after installation of the structures, or at any other suitable time. In preferred embodiments, the plant material preferably grows to a relatively limited length. Also, the plant material is preferably selected to maximize the removal of carbon from the atmosphere. Additionally, the plant material is preferably selected such that maintenance is minimized. An example of suitable plant material includes Buchloe dactyloides (alternatively known as buffalo grass), a perennial grass native to the Great Plains of North America. The benefit of such selection of plant material is that some varieties of buffalo grass only grow to approximately 4-6″. Also, buffalo grass is drought resistant and tolerates heat relatively well.

In selected embodiments, different plant material may be provided between respective support structures 110, 120, 130, or 140 on a single roof. The color, texture, length, or other characteristics of the plant material may be varied between the respective support structures. Different patterns or designs may be selected to provide aesthetic qualities to the roof of a dwelling. The length, width, size, etc. of the support structures may also be varied between support structures to enhance the aesthetic effect of the variation in plant material on the roof of a particular dwelling. Although some embodiments have been described in terms of the roof of a residential dwelling, other embodiments can be employed or adapted for roofs of commercial buildings or other appropriate structures.

In one embodiment, a customized set of arrays of support structures for assembly on a roof of a dwelling are provided. The customized set of arrays is preferably created by measuring the various dimensions of the contour of the roof. Each individual array is individually designed to conform to the measurements. Each individual array is then fabricated according to the design. The customized arrays are shipped to the respective dwelling. A suitable crane or other device is used to lift the arrays to roof for attachment to the roof.

Representative embodiments provide a method of carbon reduction that can be practiced with a relatively small amount of maintenance after installation. In the aggregate, it is believed that wide-spread use of representative embodiments enables individuals to significantly offset their carbon footprint caused by their routine daily activities.

Furthermore, in one representative embodiment, a method of brokering carbon offsets according to a regulatory environment is provided. In the method, individuals enter into contracts to have plant-growth support structures installed and/or maintained on the roof of their dwellings. As part of the contracts, the individuals agree to assign the rights to carbon offsets. Data indicative of the contractual rights are stored in a suitable database or computer system. The expected carbon offset for each dwelling is stored in the database based upon the size of the roof, the location of the dwelling, the support plant material, etc. The stored data is then utilized to offer carbon offsets (based upon the aggregated effect of the supported plant growth across numerous dwellings) to various industry entities in need of such offsets.

Although representative embodiments and advantages have been described in detail, it should be understood that various changes, substitutions and alterations can be made herein without departing from the spirit and scope of the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure that processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A system for supporting plant growth on a roof of a building, comprising:
a water-impervious base structure;
a water-permeable cover;
porous material, held between the base structure and the cover, for providing a root base for the plant growth;
one or more irrigation channels for permitting delivery of water through the base structure or cover to the synthetic or natural soil;
the cover being further adapted to permit growth of plant material from the porous material through to an exterior of the cover.

2. The system of claim 1 wherein the base structure comprises a load supporting strap arranged longitudinally along the base structure.

3. The system of claim 1 further comprising:
a resistive heating element disposed adjacent to the base structure.

4. The system of claim 1 wherein the one or more irrigation channels comprise a soaker hose.

5. The system of claim 1 wherein the porous material comprises a spiral soil root base.

6. The system of claim 1 wherein the porous material comprises a stacked layer soil root base.

7. The system of claim 1 wherein the porous material comprises open cell foam.

8. The system of claim 1 further comprising:
a non-expandable band circumscribing the base structure and the cover.

9. The system of claim 1 wherein the porous material is segmented into multiple portions with one or more barrier spacers between adjacent portions of the porous material.

10. The system of claim 1 further comprising:
a sensor for detecting an amount of moisture in the porous material.

11. A method of growing plant material on a roof of a building, comprising:
providing a plurality of support structures across the roof of the building, each support structure comprising (i) a water-impervious base structure; (ii) a water-permeable cover; (iii) porous material, held between the base structure and the cover, for providing a root base for the plant growth; (iv) one or more irrigation channels for permitting delivery of water through the base structure or cover to the synthetic or natural soil;
distributing moisture throughout the porous material of the support structures through the one or more irrigation channels of the support structures; and
growing plant material planted within the porous material through the covers of the support structures.

12. The method of claim 11 wherein each base structure comprises a load supporting strap arranged longitudinally along the base structure.

13. The method of claim 11 wherein each support structure further comprises a resistive heating element disposed adjacent to the base structure.

14. The method of claim 11 wherein the one or more irrigation channels of each support structure comprise a soaker hose.

15. The method of claim 11 wherein the porous material of each support structure comprises a spiral soil root base.

16. The method of claim 11 wherein the porous material of each support structure comprises a stacked layer soil root base.

17. The method of claim 11 wherein the porous material of each support structure comprises open cell foam.

18. The method of claim 11 wherein each support structure further comprises a non-expandable band circumscribing the base structure and the cover.

19. The method of claim 11 wherein the porous material of each support structure is segmented into multiple portions with one or more barrier spacers between adjacent portions of the porous material.

20. The method of claim 11 each support structure further comprises further comprises a sensor for detecting an amount of moisture in the porous material, the distributing occurring automatically in response to a signal from the sensor.
